(19) United States
(12) Patent Application Publication
(10) Pub. No.: US 2025/0083233 A1
(43) Pub. Date: Mar. 13, 2025

(54) SHAPE FOLLOW-UP SUPPORT DEVICE FOR SELECTIVE LASER MELTING AND METHOD THEREOF

(71) Applicant: Jiangsu University, Zhenjiang (CN)

(72) Inventors: Hongmei ZHANG, Zhenjiang (CN); Jialong DU, Zhenjiang (CN); Jinzhong LU, Zhenjiang (CN); Kaiyu LUO, Zhenjiang (CN); Haifei LU, Zhenjiang (CN); Yujie WU, Zhenjiang (CN); Yang LIU, Zhenjiang (CN)

(21) Appl. No.: 18/651,861

(22) Filed: May 1, 2024

Related U.S. Application Data
(63) Continuation of application No. PCT/CN2023/135422, filed on Nov. 30, 2023.

(30) Foreign Application Priority Data
Sep. 7, 2023 (CN) 202311145967.4

(51) Int. Cl. B22F 10/47; B22F 12/41; B33Y 10/00; B33Y 30/00

(52) U.S. Cl. CPC B22F 10/47; B22F 12/41; B33Y 10/00; B33Y 30/00

(57) ABSTRACT

A shape follow-up support device for selective laser melting and a method thereof are provided. The device includes a lifting base, where the lifting base is provided with an inner cavity, and a top wall of the lifting base is provided with multiple first through holes communicated with the inner cavity of the lifting base, and the multiple first through holes are arranged at equal intervals. Multiple driving assemblies are arranged in the lifting base; output ends of the driving assemblies extend out of the lifting base through the first through holes and are provided with support rods, and protruding ends of the support rods are detachably connected with sacrificial assemblies. A porous substrate is provided with multiple second through holes, and the multiple second through holes are in one-to-one correspondence with the multiple first through holes and communicate with the multiple first through holes.

### CROSS-REFERENCE TO RELATED APPLICATIONS

This application is a continuation of PCT/CN2023/135422, filed on Nov. 30, 2023 and claims priority of Chinese Patent Application No. 202311145967.4, filed on Sep. 7, 2023, the contents of which are hereby incorporated by reference.

### TECHNICAL FIELD

The disclosure belongs to the technical field of metal additive manufacturing, and in particular relates to a shape follow-up support device for selective laser melting and a method thereof.

### BACKGROUND

Selective laser melting (SLM) is a kind of additive manufacturing method based on powder melting technology. SLM uses a laser beam to scan layer by layer and melt metal powder to reinforce the metal powder. Different from a traditional processing technology, powder-spreading laser additive manufacturing can realize lightweight, personalized and integrated manufacturing of complex parts, and provide components with better mechanical properties, higher surface quality and dimensional accuracy.

In principle, SLM technology may manufacture metal parts with any complex shape. However, due to a fact that loose powder may not bear a load effectively during processing, the SLM technology may not perfectly fabricate geometric features such as thin plate, sharp corner and overhanging surface structures. Meanwhile, deformation and thermal stress accumulation during the processing are easy to lead to distortion or cracking. Therefore, a use of support structures is inevitable.

At present, a common method is to synchronously perform additive printing of support structures on a substrate while printing the component. Such supports have a certain strength and is convenient for conducting heat into the substrate. However, these supports demonstrate metallurgical bonding of the substrate and components, requiring a subsequent machining to remove it and might destroy the forming surface contacted with support.

### SUMMARY

In order to solve the above technical problems, the disclosure provides a shape follow-up support device for selective laser melting and a method thereof, aiming at solving or improving at least one of the above technical problems.

In order to achieve the above objective, the disclosure provides a shape follow-up support device for selective laser melting, including:
a lifting base, where the lifting base is provided with an inner cavity, and a top wall of the lifting base is provided with multiple first through holes communicated with the inner cavity of the lifting base, and the multiple first through holes are arranged at equal intervals; multiple driving assemblies are arranged in the lifting base, and the multiple driving assemblies are arranged in one-to-one correspondence with the first through holes; output ends of the driving assemblies extend out of the lifting base through the first through holes and are provided with support rods, and protruding ends of the support rods are detachably connected with sacrificial assemblies, and the sacrificial assemblies are used for a metallurgical connection with a molding workpiece; and
a porous substrate, where the porous substrate is installed on a top surface of the lifting base by bolts, and the porous substrate is provided with multiple second through holes. The multiple second through holes are in one-to-one correspondence with and communicate with the multiple first through holes, and the support rods penetrate through the second through holes.

Optionally, each of the support rods has a hollow tubular structure.

Optionally, each of the driving assemblies includes a driver, where the driver is fixedly installed in the inner cavity of the lifting base, an output end of the driver is fixedly connected with a drive shaft, and the drive shaft penetrates through each of the first through holes. The drive shaft is connected with each of the support rods, and the driver is electrically connected with an electric control element.

Optionally, the sacrificial assemblies include sacrificial blocks, where one end of each of the sacrificial blocks is connected with the each of the support rods, and another end is used for contacting with the molding workpiece, and a side wall of each of the sacrificial blocks is provided with a groove.

Optionally, one end of each of the sacrificial blocks close to each of the support rods and one end of each of the support rods close to the drive shaft are respectively fixedly connected with coaxial cylindrical pins, and the cylindrical pins are inserted into an inner cavity of each of the support rods.

Optionally, a matching tolerance between the cylindrical pins and the inner cavity of each of the support rods is H7/k6.

Optionally, apertures of the first through holes and the second through holes are equal, being 0.5-4 mm.

Optionally, a spacing between the multiple first through holes is 1-10 mm.

Optionally, a matching tolerance between each of the first through holes and the drive shaft is H8/f7.

A shape follow-up support method for selective laser melting includes following steps:
establishing Computer-Aided Design (CAD) three-dimensional model data of the molding workpiece;
preparing additives for the molding workpiece;
dismantling the molding workpiece; and
bending along the groove, sandblasting, polishing and trimming a surface of the molding workpiece.

Compared with the prior art, the disclosure has following advantages and technical effects.

According to the disclosure, by arranging the multiple support rods, an array of multi-point shape follow-up supports may adapt to a support of a complex overhanging surface, thereby avoiding a preparation of support structures in a process of selective laser melting, and facilitating to improve a processing efficiency and a surface quality of the molding workpiece.

According to the disclosure, a metallurgical connection is formed between the sacrificial assemblies detachably connected to tops of the support rods and the molding workpiece. After a preparation of the additives of the molding workpiece is completed, the sacrificial assemblies are separated from the support rods along with the molding workpiece. The sacrificial assemblies are easy to be disassembled and trimmed, which reduces a workload of subsequent support structures of the molding workpiece.

### BRIEF DESCRIPTION OF THE DRAWINGS

Accompanying drawings, which constitute a part of this disclosure, are used to provide a further understanding of this disclosure. Illustrative embodiments of this disclosure and their descriptions are used to explain this disclosure, and do not constitute an improper limitation of this disclosure. In the attached drawings:

FIG. 1 is a schematic diagram of an overall structure of the disclosure,

FIG. 2 is a sectional view of the disclosure,

FIG. 3 is a schematic diagram of a connection between a sacrificial block and a support rod of the disclosure, and

FIG. 4 is a flow chart of the disclosure.

### DETAILED DESCRIPTION OF THE EMBODIMENTS

In the following, technical schemes in embodiments of the disclosure may be clearly and completely described in combination with attached drawings in embodiments of the disclosure. Obviously, the described embodiments are only a part of the embodiments of the disclosure, but not all embodiments. Based on the embodiments in the disclosure, all other embodiments obtained by those of ordinary skill in the art without creative efforts belong to a scope of protection of the disclosure.

In order to make above objects, features and advantages of the disclosure more obvious and easier to understand, the disclosure may be further described in detail, in combination with the attached drawings and specific embodiments.

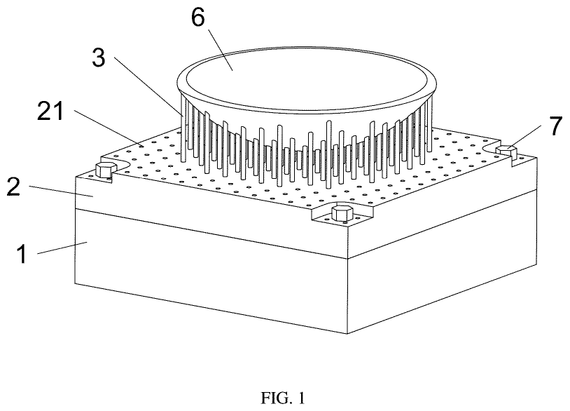

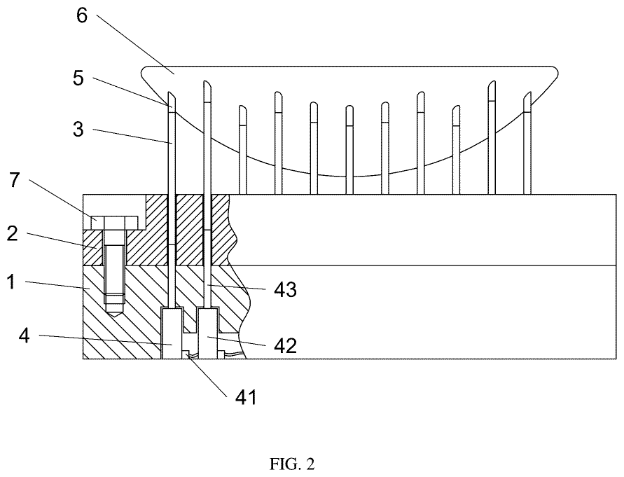

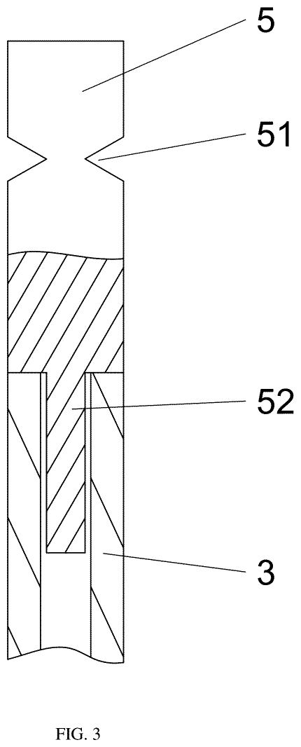

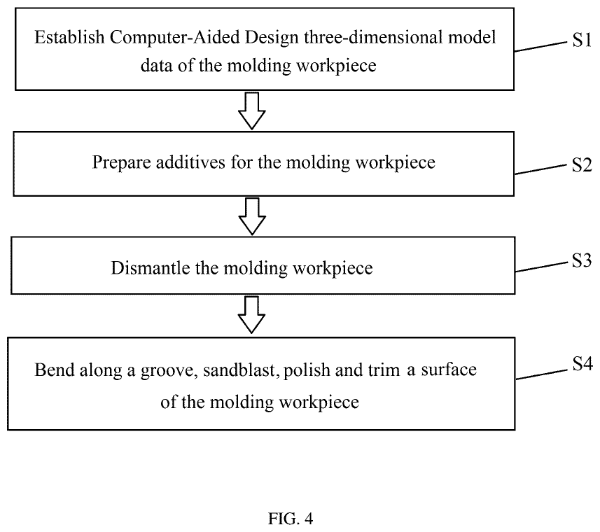

With reference to FIG. 1-FIG. 4, this embodiment provides a shape follow-up support device for selective laser melting, including:
a lifting base 1, where the lifting base 1 is provided with an inner cavity, and a top wall of the lifting base 1 is provided with multiple first through holes communicated with the inner cavity of the lifting base 1, and the multiple first through holes are arranged at equal intervals; multiple driving assemblies 4 are arranged in the lifting base 1, and the multiple driving assemblies 4 are arranged in one-to-one correspondence with the first through holes; an output end of the driving assembly 4 extends out of the lifting base 1 through the first through hole and is provided with a support rod 3, and a protruding end of the support rod 3 is detachably connected with a sacrificial assembly, and the sacrificial assembly is used for metallurgically connecting with a molding workpiece 6; and
a porous substrate 2, where the porous substrate 2 is installed on a top surface of the lifting base 1 by bolts 7, and the porous substrate 2 is provided with multiple second through holes 21, and the multiple second through holes 21 are in one-to-one correspondence with the multiple first through holes and communicate with the multiple first through holes, and the support rods 3 penetrate through the second through holes 21.

By arranging the multiple support rods 3, an array of multi-point shape follow-up supports may adapt to a support of a complex overhanging surface, thereby avoiding a preparation of support structures in a process of selective laser melting, and facilitating to improve a processing efficiency and a surface quality of the molding workpiece 6.

The metallurgical connection is formed between the sacrificial assemblies detachably connected to tops of the support rods 3 and the molding workpiece, so that the sacrificial assemblies may be separated from the support rods 3 along with the molding workpiece 6 after a preparation of additives of the molding workpiece 6 is completed. The sacrificial assemblies are easy to be disassembled and trimmed, which reduces a workload of subsequent support structures of the molding workpiece.

In an embodiment, each of the support rods 3 is a hollow tubular structure, and the support rods 3 are preferably made of tungsten steel, titanium alloy and other materials.

In an embodiment, the driving assembly 4 includes a driver 42, where the driver 42 is fixedly installed in the inner cavity of the lifting base 1, the output end of the driver 42 is fixedly connected with a drive shaft 43, and the drive shaft 43 penetrates through the first through hole. The drive shaft 43 is connected with the support rod 3, and the driver 42 is electrically connected with an electric control element 41.

The driver 42 is controlled by the electric control element 41 to lift the drive shaft 43, so that the support rod 3 is driven to ascend and descend synchronously by the drive shaft 43.

In an embodiment, the sacrificial assembly includes a sacrificial block 5, where one end of the sacrificial block 5 is connected with the support rod 3, and an other end of the sacrificial block 5 is used for contacting with the molding workpiece 6, and a side wall of the sacrificial block 5 is provided with a groove 51.

The sacrificial block 5 is made of the same material as the molding workpiece 6, and the groove 51 is easy to bend and to be trimmed.

In an embodiment, one end of the sacrificial block 5 close to the support rod 3 and one end of the support rod 3 close to the drive shaft 43 are respectively fixedly connected with coaxial cylindrical pins 52, and the cylindrical pins 52 are inserted into an inner cavity of the support rod 3.

A detachable connection between the support rod 3 and the sacrificial block 5, and a detachable connection between the drive shaft 43 and the support rod 3 are facilitated by arranging the cylindrical pins 52.

In an embodiment, a matching tolerance between the cylindrical pins 52 and the inner cavity of the support rod 3 is H7/k6.

In an embodiment, apertures of the first through holes and the second through holes 21 are equal, which are 0.5-4 mm.

In an embodiment, a spacing between the multiple first through holes is 1-10 mm.

In an embodiment, a matching tolerance between the first through hole and the drive shaft 43 is H8/f7.

A shape follow-up support method for selective laser melting is provided, the method includes following steps.

CAD three-dimensional model data of the molding workpiece 6 is established, data of a lower surface of the molding workpiece to be supported is obtained, and the data is placed in a Cartesian coordinate system to obtain a height from an end of the each of the drive shafts 43 distributed in an array to the lower surface of the molding workpiece 6, which is called a preset height h (i, j), where i∈ (1, 2, . . . , N), and N is a number of openings of the second through holes 21 of the porous substrate 2 in an X direction, J∈ (1, 2, . . . , K), and K is a number of holes of the second through holes 21 of the porous substrate 2 in a Y direction; and the CAD three-dimensional model data of the molding workpiece 6 is sliced to obtain data of each slice layer, and a selective additive system is started.

The additives for the molding workpiece are prepared, a height of a powder layer is lowered through the lifting base 1 with a whole body; when extension lengths of the drive shafts 43 do not reach the preset height h (i, j), the drivers 42 are started by the electric control elements 41 to raise the support rods 3 by the height of the powder layer, and the powder laying is performed by a selective laser melting system. At this time, a height of a top of the powder layer is consistent with heights of ends of sacrificial blocks 5 that do not reach the preset height h (i, j); a laser is activated to act on a surface of the powder layer for selective laser melting or sintering processing, and the above steps are repeated until the molding workpiece 6 is prepared;

The molding workpiece 6 is dismantled, the molding workpiece 6 is lifted vertically, and the sacrificial blocks 5 which are metallurgically connected with the molding workpiece 6 are separated from support units.

The sacrificial block 5 is bent along the groove, the surface of the molding workpiece is sandblasted, polished and trimmed.

In this embodiment, a hemispherical workpiece is used, a surface is hemispherical with a diameter of 80 mm and a thickness of 4 mm. The component is made of Ti6Al4V powder with a particle size of 15-53 μm, and a top of the lifting base is provided with an array of 20×20 circular through holes, with a spacing t of 5 mm and an aperture d of 0.5 mm. Sacrificial units are made of a Ti6A14V material. CAD three-dimensional model data of the hemispherical workpiece is established, and data of the lower surface to be supported is obtained, and the data is placed in a Cartesian coordinate system, and a height from an end of each of drive shafts of drive units distributed in an array to the lower surface of the molding workpiece is obtained, which is called a preset height h (i, j), where i∈ (1, 2, . . . , 20); J∈ (1, 2, . . . , 20), and then the above method is adopted.

In a description of the disclosure, it should be understood that orientation or positional relationships indicated by terms “vertical”, “horizontal”, “up”, “down”, “front”, “back”, “left”, “right”, “vertical”, “horizontal”, “top”, “bottom”, “inside”, “outside” are based on orientation or positional relationships shown in accompanying drawings, solely for a convenience of describing the disclosure, rather than indicating or implying that a device or a component referred to must have a specific orientation, be constructed and operated in a specific orientation, therefore it may not be understood as a limitation of the disclosure.

The above-mentioned embodiments only describe preferred modes of the disclosure, and do not limit a scope of the disclosure. Under a premise of not departing from a design spirit of the disclosure, various modifications and improvements made by those of ordinary skill in the art to the technical scheme of the disclosure shall fall within a protection scope determined by claims of the disclosure.

1. A shape follow-up support device for selective laser melting, comprising:
a lifting base, wherein the lifting base is provided with an inner cavity, and a top wall of the lifting base is provided with a plurality of first through holes communicated with the inner cavity of the lifting base, and the plurality of first through holes are arranged at equal intervals; a plurality of driving assemblies are arranged in the lifting base, and the plurality of driving assemblies are arranged in one-to-one correspondence with the first through holes; output ends of the driving assemblies extend out of the lifting base through the first through holes and are provided with support rods, and protruding ends of the support rods are detachably connected with sacrificial assemblies, and the sacrificial assemblies are used for metallurgical fusion with a molding workpiece; and
a porous substrate, wherein the porous substrate is installed on a top surface of the lifting base by bolts, and the porous substrate is provided with a plurality of second through holes; the plurality of second through holes are in one-to-one correspondence with and communicate with the plurality of first through holes, and the support rods penetrate through the second through holes;
each of the driving assemblies comprises a driver, wherein the driver is fixedly installed in the inner cavity of the lifting base, an output end of the driver is fixedly connected with a drive shaft, and the drive shaft penetrates through each of the first through holes; the drive shaft is connected with each of the support rods, and the driver is electrically connected with an electric control element;
the sacrificial assemblies comprise sacrificial blocks, wherein one end of each of the sacrificial blocks is connected with each of the support rods, and another end is used for contacting with the molding workpiece, and a side wall of each of the sacrificial blocks is provided with a groove; and
one end of each of the sacrificial blocks close to each of the support rods and one end of each of the support rods close to the drive shaft are respectively fixedly connected with coaxial cylindrical pins, and the cylindrical pins are inserted into an inner cavity of each of the support rods.

2. The shape follow-up support device for selective laser melting according to claim 1, wherein each of the support rods has a hollow tubular structure.

3. The shape follow-up support device for selective laser melting according to claim 1, wherein a matching tolerance between the cylindrical pins and the inner cavity of each of the support rods is H7/k6.

4. The shape follow-up support device for selective laser melting according to claim 1, wherein apertures of the first through holes and the second through holes are equal, being 0.5-4 millimeters.

5. The shape follow-up support device for selective laser melting according to claim 1, wherein a spacing between the plurality of first through holes is 1-10 millimeters.

6. The shape follow-up support device for selective laser melting according to claim 1, wherein a matching tolerance between each of the first through holes and the drive shaft is H8/f7.

7. A shape follow-up support method for selective laser melting, based on the shape follow-up support device for selective laser melting according to claim 1, comprising following steps:
establishing Computer-Aided Design three-dimensional model data of the molding workpiece;preparing additives for the molding workpiece;
dismantling the molding workpiece; and
bending along the groove, sandblasting, polishing and trimming a surface of the molding workpiece.
